(19) United States
(12) Patent Application Publication
(10) Pub. No.: US 2020/0290248 A1
(43) Pub. Date: Sep. 17, 2020

(54) FORMED MEMBER HAVING METAL SHEET AND METHOD FOR MANUFACTURING SAME

(71) Applicant: LOTES CO., LTD, Keelung (TW)

(72) Inventors: Chin Chi Lin, Keelung (TW); Yu Sheng Chen, Keelung (TW)

(21) Appl. No.: 16/718,337

(22) Filed: Dec. 18, 2019

(30) Foreign Application Priority Data
Mar. 11, 2019 (CN) 201910180318.5

(51) Int. Cl. B29C 45/14; B29C 45/27; H01R 13/516; H01R 43/18; H01R 43/16; H01R 43/24; H01R 13/502

(52) U.S. Cl. CPC B29C 45/14; B29C 45/27; H01R 13/516; H01R 13/502; H01R 43/16; H01R 43/24; H01R 43/18

(57) ABSTRACT

A method for manufacturing a formed member is provided. A metal sheet is provided in a mold including a mold cavity. An upper end as well as each of left and right sides of the mold cavity are in communication with at least one first upper runner channel and at least one side runner channel. A liquid insulating material is injected into the mold and flows into the mold cavity from the first upper runner channel and the side runner channel respectively. After the liquid insulating material is solidified, a body is formed in the mold cavity, a first upper connecting portion is formed in each first upper runner channel, and a side connecting portion is formed in each side runner channel. Then the formed member is obtained by disconnecting the joints of the body and each of the first upper connecting portion as well as the side connecting portion.

### CROSS-REFERENCE TO RELATED PATENT APPLICATION

This non-provisional application claims priority to and the benefit of, pursuant to 35 U.S.C. § 119(a), patent application Serial No. CN 201910180318.5 filed in China on Mar. 11, 2019. The disclosures of the above applications are incorporated herein in their entireties by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a formed member and a method for manufacturing the same, and particularly to a formed member having a metal sheet and a method for manufacturing the same.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing formed member includes a metal sheet and a plastic member injection-molded together with the metal sheet.

With development of the formed member being miniaturized and thinned, the plastic member is usually slender, resulting in a mold cavity correspondingly forming the plastic member to be also slender. Currently, the liquid plastic is usually filled by vertical point plastic feeding, and the space above the slender mold cavity for provide plastic feeding runner channels is insufficient, resulting in a small quantity of the plastic feeding runner channels. In this case, an excessively small flow rate of the liquid plastic does not flow uniformly in the slender mold cavity, resulting in a short shot phenomenon to the plastic member in the injection molding process.

Therefore, a heretofore unaddressed need to design an improved manufacturing method exists in the art to address the aforementioned deficiencies and inadequacies.

### SUMMARY

The present invention is directed to a formed member capable of implementing complete filling the mold by injection molding and a method for manufacturing the same.

To achieve the foregoing objective, the present invention adopts the following technical solutions.

A method for manufacturing a formed member having a metal sheet includes: step S1: providing the metal sheet; step S2: providing a mold, comprising a mold cavity, at least one first upper runner channel and a plurality of side runner channels, wherein an upper end of the mold cavity is in communication with the at least one first upper runner channel, each of a left side and a right side of the mold cavity is in communication with at least one of the side runner channels respectively, the metal sheet is placed in the mold, a liquid insulating material is injected into the mold, the liquid insulating material flows into the mold cavity from the at least one first upper runner channel and the side runner channels respectively, and after the liquid insulating material is solidified, a body is formed in the mold cavity and fixed to the metal sheet, a first upper connecting portion is formed in each of the at least one first upper runner channel, and a side connecting portion is formed in each of the side runner channels; and step S3: obtaining the formed member by disconnecting a joint of each of the first upper connecting portion and the body and a joint of each of the side connecting portion and the body.

In certain embodiments, in the step S1, at least one protruding portion is formed by stamping at each of a left side and a right side of the metal sheet; and in the step S2, each of the at least one side runner channel is in communication to a lower surface of a corresponding one of the at least one protruding portion, and the liquid insulating material flows into the mold cavity from the side runner channel along the lower surface of the corresponding one of the at least one protruding portion.

In certain embodiments, in the step S3, the side connecting portion is pulled downward to be disconnected from the body and form a side broken surface on the body.

In certain embodiments, in the step S1, the metal sheet is stamped to form a plurality of through holes, and the through holes are arranged on a straight line in a front-rear direction; and in the step S2, the upper end of the mold cavity is in communication with a plurality of first upper runner channels, each of the first upper runner channels is in communication with one of the through holes, and at least one of the through holes is provided between two adjacent ones of the first upper runner channels.

In certain embodiments, in the step S1, the metal sheet is stamped to form a plurality of through slots, each of the through holes is located between two corresponding ones of the through slots in a left-right direction, and each of the through holes and the two corresponding ones of the through slots are arranged on a straight line in the left-right direction; and in the step S2, the liquid insulating material flows into the through slots through the mold cavity, and after the liquid insulating material is solidified, the body is fixed to the through slots.

In certain embodiments, the mold comprises an upper mold and a lower mold pressed with each other, and the step S3 is divided into steps S3-1, S3-2 and S3-3 sequentially performed, comprising: step S3-1: moving the upper mold upward to drive the first upper connecting portion to move upward, and disconnecting the first upper connecting portion from the body and form an upper broken surface on the body; step S3-2: moving the metal sheet, the side connecting portion and the body upward to be completely separated from the lower mold; and step S3-3: obtaining the formed member formed by the metal sheet and the body by pulling the side connecting portion downward to be disconnected from the body and removing the side connecting portion.

In certain embodiments, the mold comprises a plurality of first upper runner channels and a plurality of second upper runner channels, the first upper runner channels and the second upper runner channels are all provided to extend vertically, and each of the second upper runner channels is in communication with one of the side runner channels; and in the step S2, the liquid insulating material flows into the corresponding side runner channels from the second upper runner channels, and a second upper connecting portion is formed in each of the second upper runner channels to be connected to the corresponding side connecting portion.

In certain embodiments, the mold comprises an upper mold and a lower mold pressed with each other; and in the step S3, the upper mold is moved upward to drive the first upper connecting portion and the second upper connecting portions to move upward, the first upper connecting portion is disconnected from the body, and each of the second upper connecting portions is disconnected from the corresponding side connecting portion.

In certain embodiments, the second upper connecting portions are arranged in two rows in a left-right direction, the first upper connecting portions are arranged in a row in a front-rear direction, the first upper connecting portions in the row are located between the second upper connecting portions in the two rows in the left-right direction, and each of the first upper connecting portions and each of the second upper connecting portions in the two rows adjacent thereto are provided staggeredly in the front-rear direction.

A method for manufacturing a formed member having a metal sheet includes: step S1: providing the metal sheet; step S2: providing a mold, comprising a left mold cavity, a middle mold cavity and a right mold cavity separated from one another, wherein a left side of the left mold cavity is in communication with at least one left side runner channel, an upper end of the middle mold cavity is in communication with at least one first upper runner channel, a right side of the right mold cavity is in communication with at least one right side runner channel, the metal sheet is placed in the mold, a liquid insulating material is injected into the mold, the liquid insulating material flows into the left mold cavity, the middle mold cavity and the right mold cavity correspondingly from the left side runner channel, the first upper runner channel and the right side runner channel respectively, after the liquid insulating material is solidified, a left body is formed in the left mold cavity, a middle body is formed in the middle mold cavity, a right body is formed in the right mold cavity, the left body, the middle body and the right body are separated from one another and fixed to the metal sheet respectively, a left side connecting portion is formed in each of the at least one left side runner channel, a first upper connecting portion is formed in each of the at least one first upper runner channel, and a right side connecting portion is formed in each of the at least one right side runner channel; and step S3: obtaining the formed member by disconnecting a joint of each of the left side connecting portion and the left body, a joint of each of the first upper connecting portion and the middle body, and a joint of each of the right side connecting portion and the right body.

In certain embodiments, in the step S1, at least one protruding portion is formed by stamping at each of a left side and a right side of the metal sheet; and in the step S2, each of the at least one left side runner channel is in communication to a lower surface of a corresponding one of the at least one protruding portion located at the left side of the metal sheet, the liquid insulating material flows into the left mold cavity from the left side runner channel along the lower surface of the corresponding one of the at least one protruding portion located at the left side of the metal sheet, each of the at least one right side runner channel is in communication to a lower surface of a corresponding one of the at least one protruding portion located at the right side of the metal sheet, and the liquid insulating material flows into the right mold cavity from the right side runner channel along the lower surface of the corresponding one of the at least one protruding portion located at the right side of the metal sheet.

In certain embodiments, in the step S3, the left side connecting portion is pulled downward to be disconnected from the left body and form a left side broken surface on the left body, and the right side connecting portion is pulled downward to be disconnected from the right body and form a right side broken surface on the right body.

In certain embodiments, in the step S1, the metal sheet is stamped to form a plurality of through holes, and the through holes are arranged on a straight line in a front-rear direction; and in the step S2, the upper end of the middle mold cavity is in communication with a plurality of first upper runner channels, each of the first upper runner channels is in communication with one of the through holes, and at least one of the through holes is provided between two adjacent ones of the first upper runner channels.

In certain embodiments, the mold comprises a plurality of first upper runner channels and a plurality of second upper runner channels, the first upper runner channels and the second upper runner channels are all provided to extend vertically, and each of the second upper runner channels is in communication with one of the at least one left side runner channel or one of the at least one right side runner channel; and in the step S2, the liquid insulating material flows into the corresponding left side runner channel and the corresponding right side runner channel from the second upper runner channels, and a second upper connecting portion is formed in each of the second upper runner channels to be connected to the corresponding left side connecting portion or the corresponding right side connecting portion.

In certain embodiments, the mold comprises an upper mold and a lower mold pressed with each other; and in the step S3, the upper mold is moved upward to drive the first upper connecting portions and the second upper connecting portions to move upward, the first upper connecting portions are disconnected from the body, and the second upper connecting portions are disconnected from the corresponding left side connecting portion and the corresponding right side connecting portion.

In certain embodiments, the second upper connecting portions are arranged in two rows in a left-right direction, the first upper connecting portions are arranged in a row in a front-rear direction, the first upper connecting portions in the row are located between the second upper connecting portions in the two rows in the left-right direction, and each of the first upper connecting portions and each of the second upper connecting portions in the two rows adjacent thereto are provided staggeredly in the front-rear direction.

In certain embodiments, the left body and the middle body are structurally different, and the left body and the right body are provided symmetrically relative to the middle body.

A formed member includes: a metal sheet; and a body, injection-molded together with the metal sheet, wherein a left side of the body has at least one left side broken surface, an upper end of the body has at least one upper broken surface, and a right side of the body has at least one right side broken surface.

In certain embodiments, the body comprises a left body, a middle body and a right body separated from one another, a left side of the left body has the at least one left side broken surface, an upper end of the middle body has the at least one upper broken surface, and a right side of the right body has the at least one right side broken surface.

In certain embodiments, the left body and the middle body are structurally different, and the left body and the right body are provided symmetrically relative to the middle body.

In certain embodiments, at least one protruding portion is protrudingly provided at each of a left side and a right side of the metal sheet, each of the at least one left side broken surface is provided corresponding to one of the protruding portion located at the left side of the metal sheet in a left-right direction, and each of the at least one right side broken surface is provided corresponding to one of the protruding portion located at the right side of the metal sheet in the left-right direction.

In certain embodiments, the sheet metal is provided with a plurality of through slots, each of the through slots is provided corresponding to one of the protruding portion in the left-right direction, the body is located below the metal sheet, the body is provided with a plurality of clamping blocks protruding toward the through slots correspondingly, and each of the clamping blocks is fixed to a corresponding one of the through slots and protrudes upward out of the corresponding one of the through slots.

In certain embodiments, the sheet metal is provided with a plurality of through holes, the through holes are arranged on a straight line in a front-rear direction, the body is located below the metal sheet, the body is provided with a plurality of protruding blocks protruding toward the through holes correspondingly, each of the protruding blocks is fixed to a corresponding one of the through holes and protrudes upward out of the corresponding one of the through holes, at least two of the protruding blocks are respectively provided with upper broken surfaces at upper ends thereof, and at least one of the through holes is provided between two adjacent ones of the protruding blocks provided with the upper broken surfaces.

Compared with the related art, certain embodiments of the present invention has the following beneficial effects.

In certain embodiments of the present invention, the liquid insulating material flows into the mold cavity from the first upper runner channels and the side runner channels. That is, a manner of feeding the liquid insulating material from the side runner channels is additionally adopted. With the premise that the quantity of the first upper runner channels is unchanged, the side runner channels are additionally provided by fully utilizing the space of the mold cavity, thereby increasing a flow rate of the liquid insulating material flowing into the mold cavity, and further implementing uniform plastic feeding and completely filling the formed member by to injection molding.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective assembled view of a flexible circuit board according to certain embodiments of the present invention.

FIG. 2 is a perspective exploded view of the flexible circuit board in FIG. 1 after removing an insulating layer therefrom.

FIG. 3 is a sectional view of FIG. 1.

FIG. 4 is a partial enlarged view of FIG. 3.

FIG. 5 is a perspective view of an upper metal sheet according to certain embodiments of the present invention.

FIG. 6 is a perspective view of an upper formed member according to certain embodiments of the present invention.

FIG. 7 is a partial enlarged view of FIG. 6.

FIG. 8 is a perspective view of the upper formed member of FIG. 6 being 180° inversed.

FIG. 9 is a partial enlarged view of FIG. 8.

FIG. 10 is a perspective view of the upper formed member of FIG. 6 connected with connecting portions.

FIG. 11 is a top view of FIG. 10.

FIG. 12 is a sectional view of the upper formed member in a forming process along an A-A direction in FIG. 11 according to certain embodiments of the present invention.

FIG. 13 is a sectional view of the upper formed member in the forming process along a B-B direction in FIG. 11 according to certain embodiments of the present invention.

FIG. 14 is a schematic view of upward separation of an upper mold from a lower mold in FIG. 13.

FIG. 15 is a schematic view of separation of an upper connecting portion from the upper mold in FIG. 14.

FIG. 16 is a schematic view of separation of an upper metal sheet, an upper body and side connecting portions from the lower mold in FIG. 14.

FIG. 17 is a schematic view of downward pulling the side connecting portions in FIG. 16.

FIG. 18 is a schematic view of an upper formed member obtained after removing the side connecting portions in FIG. 17.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

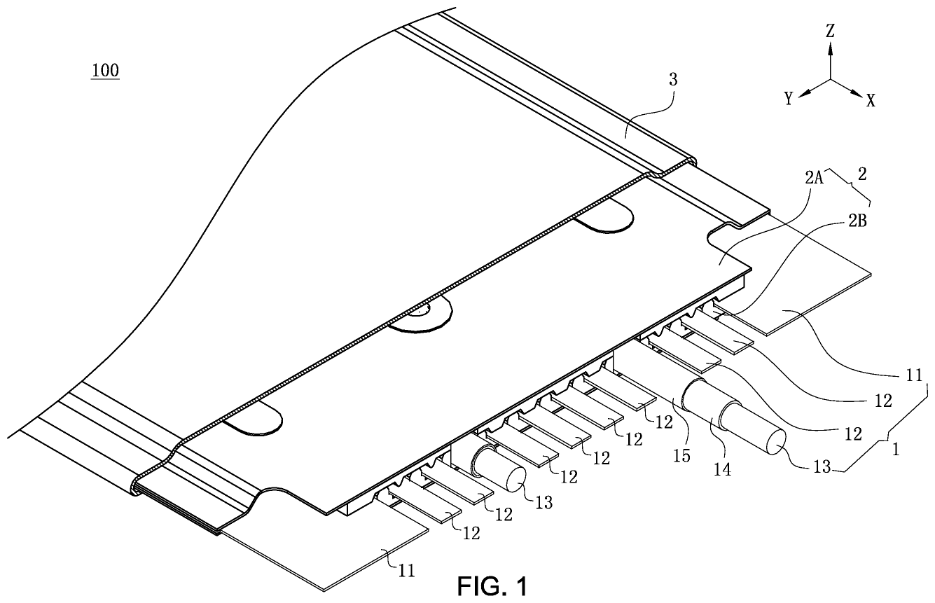

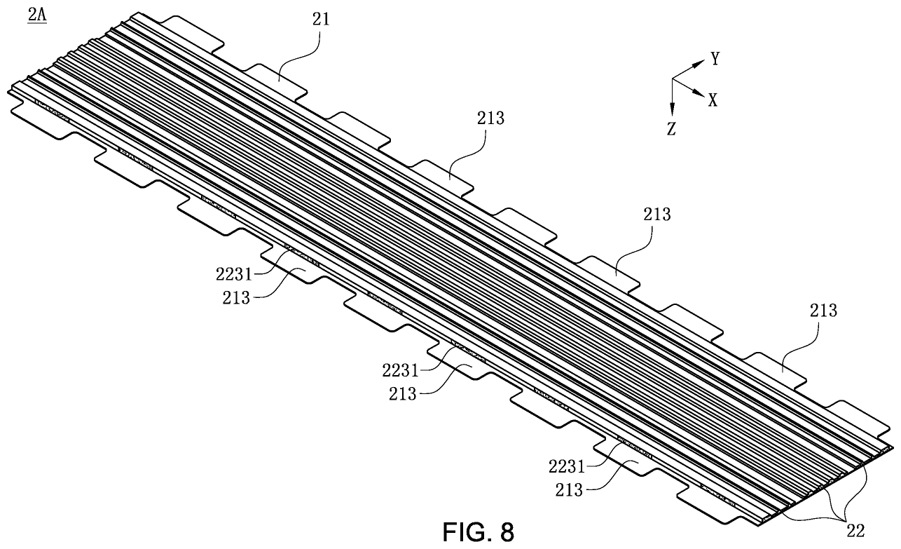

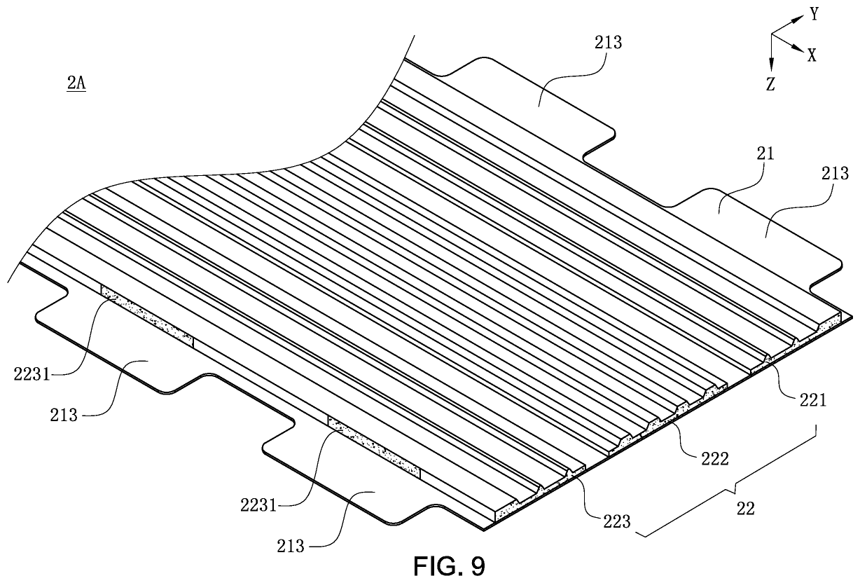

The description will be made as to the embodiments of the present invention in conjunction with the accompanying drawings in FIGS. 1-18. In accordance with the purposes of this invention, as embodied and broadly described herein, this invention, in one aspect, relates to a formed member having a metal sheet and a method for manufacturing the same.

Certain embodiments of the present invention define that an X axis is a front-rear direction, a Y axis is a left-right direction and a Z axis is a vertical direction (i.e., an up-down direction).

FIG. 1 to FIG. 3 show a flexible circuit board 100 according to certain embodiments of the present invention, which includes multiple electric conductors 1, a formed member 2 fixing the electric conductors 1, and an insulating layer 3 wrapping a periphery of the formed member 2.

As shown in FIG. 1 to FIG. 3, twelve electric conductors 1 are provided and are arranged in a single row in the Y-axis direction, including, sequentially rightward from left thereof, a ground body 11, two signal bodies 12, a power body 13, four signal bodies 12, a power body 13, two signal bodies 12 and a ground body 11. The two signal bodies 12 located between their adjacent power body 13 and ground body 11 form a differential pair to transmit differential signals.

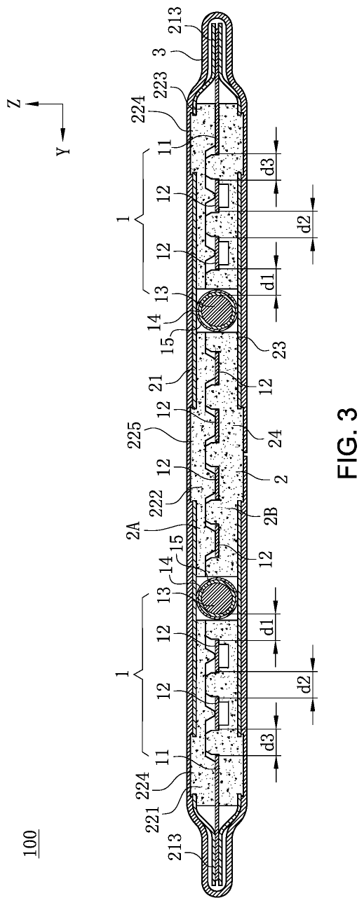

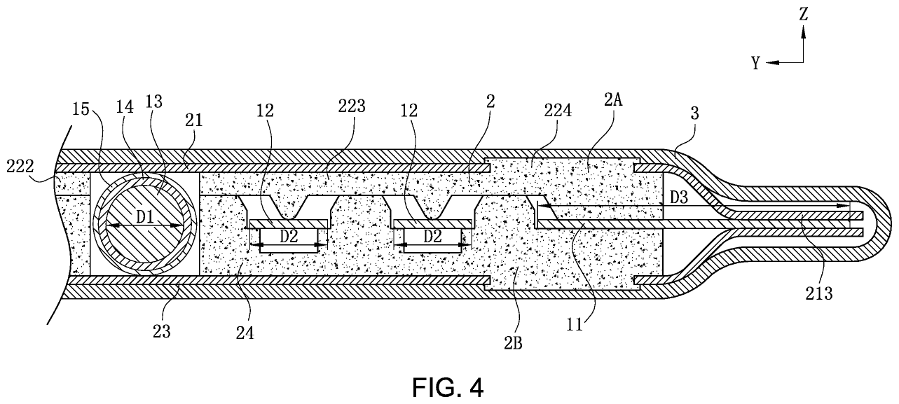

As shown in FIG. 3 and FIG. 4, the power bodies 13 are cylindrical shaped, and a periphery of each power body 13 is sequentially wrapped with an insulator 14 and a shielding body 15. Both of the signal bodies 12 and the ground bodies 11 are flat shaped. A diameter D1 of each power body 13 is equal to a width D2 of each signal body 12 in the Y-axis direction and smaller than a width D3 of each ground body 11 in the Y-axis direction. A distance between each power body 13 and its adjacent signal body 12 is d1. A distance between the two signal bodies 12 forming the differential pair is d2. A distance between each ground body 11 and its adjacent signal body 12 is d3. The distance d1, the distance d2 and the distance d3 are all equal. Each ground body 11 extends beyond the formed member 2 in the Y-axis direction.

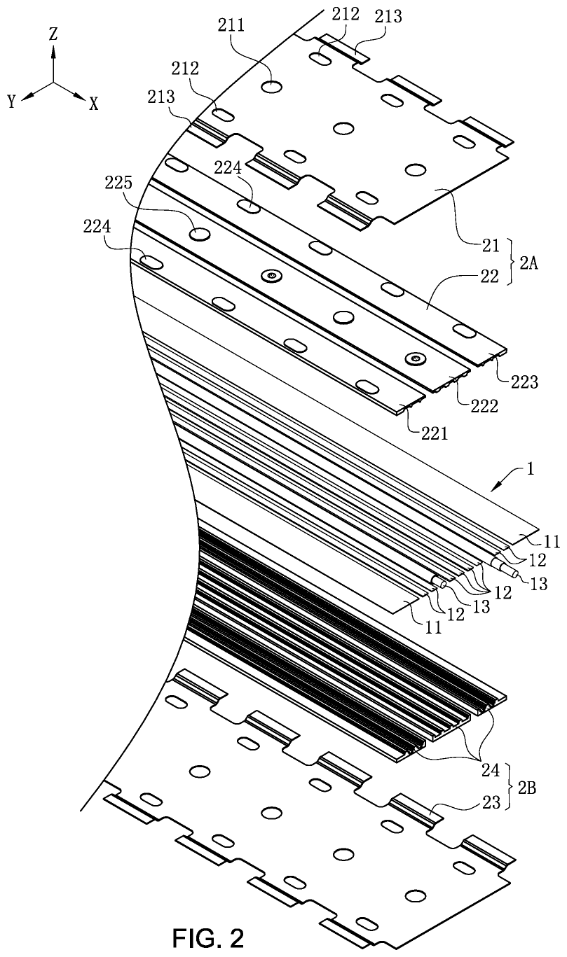

As shown in FIG. 2 to FIG. 4, the formed member 2 includes an upper formed member 2A and a lower formed member 2B pressed with each other. The upper formed member 2A and the lower formed member 2B are pressed with each other vertically to fix the electric conductors 1.

As shown in FIG. 2 and FIG. 3, the upper formed member 2A includes an upper metal sheet 21 and an upper body 22 injection-molded together with the upper metal sheet 21.

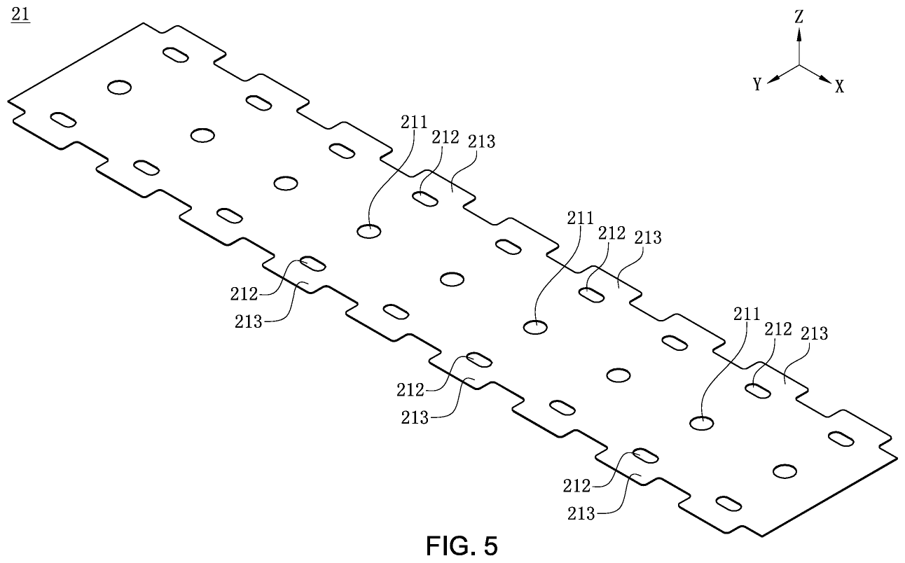

As shown in FIG. 5, the upper metal sheet 21 is provided with multiple through holes 211 and multiple through slots 212. Multiple protruding portions 213 are provided at each of left and right sides of the upper metal sheet 21 and protruding outward. The through holes 211 and the through slots 212 have different structures. Each through hole 211 is located between two adjacent through slots 212 in the Y-axis direction. Each through slot 212 is provided corresponding to one of the protruding portions 213 in the Y-axis direction, and two adjacent through slots 212 are located between two adjacent protruding portions in the Y-axis direction. In the present embodiment, the two adjacent protruding portions 213, the two adjacent through slots 212 and one of the through holes 211 are arranged on a straight line in the Y-axis direction. In other embodiments, there may also be only one through hole 211 and only one through slot 212, and there may also be only two protruding portions 213 respectively provided at the left and right sides of the upper metal sheet 21.

As shown in FIG. 1 to FIG. 3, the protruding portion 213 at the left side of the upper metal sheet 21 bends toward a corresponding ground body 11 and abuts the corresponding ground body 11. The protruding portion 213 at the right side of the upper metal sheet 21 bends toward the other corresponding ground body 11 and abuts the other corresponding ground body 11.

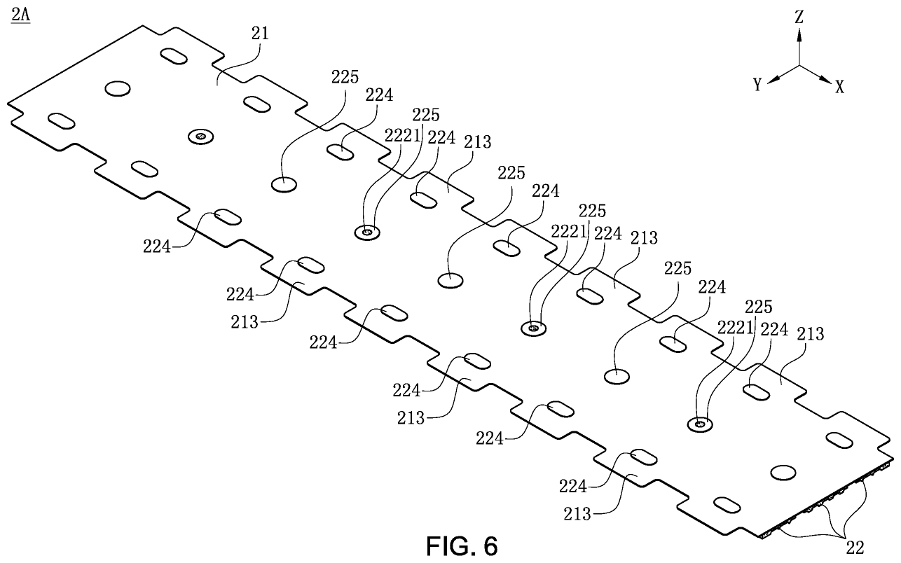

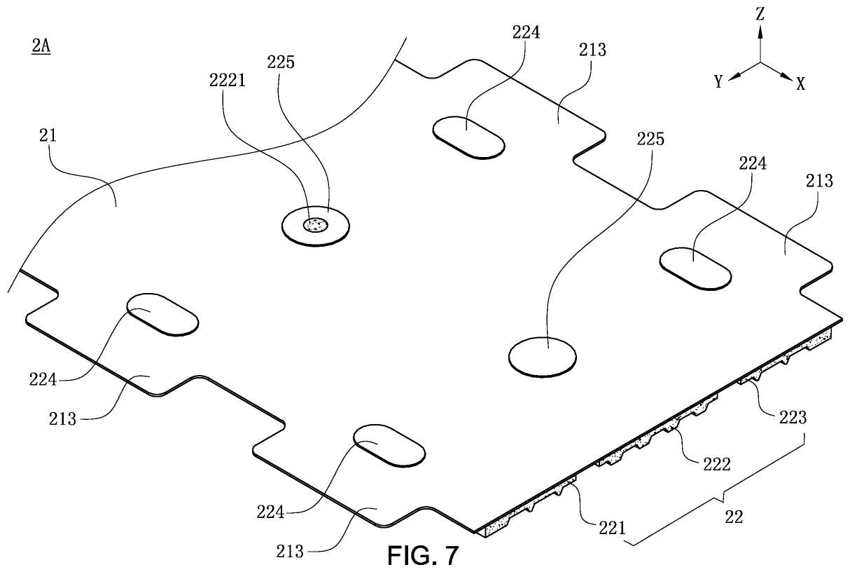

As shown in FIG. 3, FIG. 6 and FIG. 7, the upper body 22 is located below the upper metal sheet 21. The upper body 22 includes a left body 221, a middle body 222 and a right body 223 separated from one another. The left body 221 and the middle body 222 are structurally different, and the left body 221 and the right body 223 are provided symmetrically relative to the middle body 222. The left body 221, the middle body 222 and the right body 223 are fixed on the upper metal sheet 21 respectively. One power body 13 is provided between the left body 221 and the middle body 222, and the other power body 13 is provided between the middle body 222 and the right body 223. In other embodiments, the left body 221, the middle body 222 and the right body 223 may also be connected to form an integral structure.

As shown in FIG. 3, FIG. 5 and FIG. 6, each of the left body 221 and the right body 223 is provided with a plurality of clamping blocks 224 protruding toward the through slots 212 correspondingly. Each clamping block 224 is fixed with the corresponding through slot 212 and protrudes upward from the corresponding through slot 212. The middle body 222 is provided with a plurality of protruding blocks 225 protruding toward the through holes 211 correspondingly. Each protruding block 225 is fixed with the corresponding through hole 211 and protrudes upward from the corresponding through hole 211.

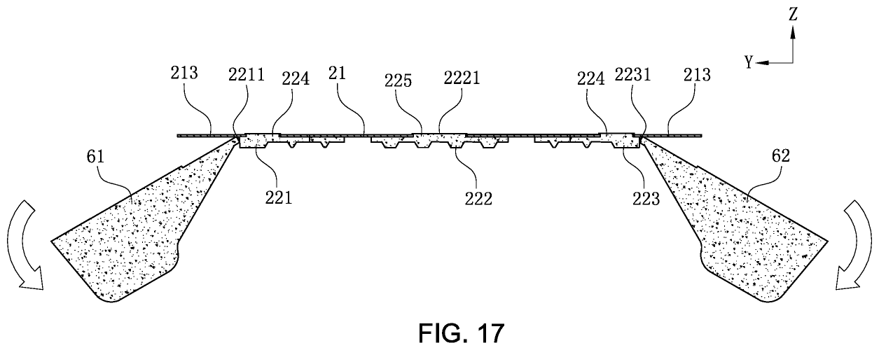

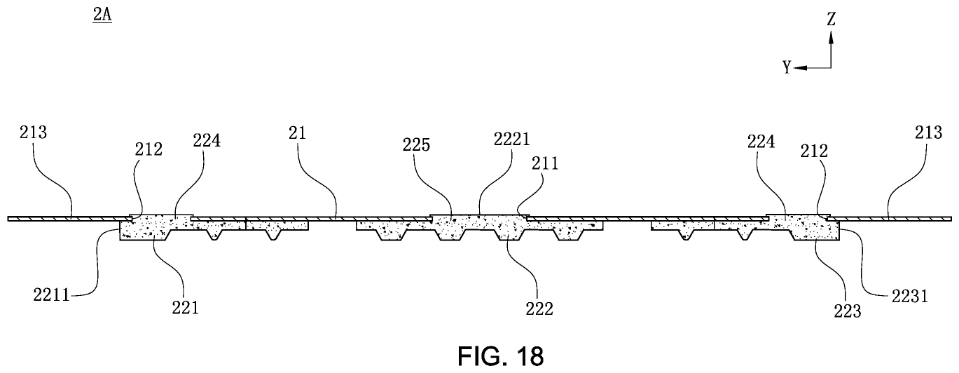

As shown in FIG. 6 to FIG. 9, a left side of the left body 221 has multiple left side broken surfaces 2211 (referring to FIG. 17 and FIG. 18), an upper end of the middle body 222 has multiple upper broken surfaces 2221, and a right side of the right body 223 has multiple right side broken surfaces 2231. The structures and quantities of the left side broken surfaces 2211 and the right side broken surfaces 2231 are the same. Each left side broken surface 2211 is provided corresponding to one protruding portion 213 at the left side of the upper metal sheet 21 in the Y-axis direction (referring to FIG. 17 and FIG. 18). Each right side broken surface 2231 is provided corresponding to one protruding portion 213 at the right side of the upper metal sheet 21 in the Y-axis direction. In other embodiments, there may be only one left side broken surface 2211, only one upper broken surface 2221 and only one right side broken surface 2231.

As shown in FIG. 5 and FIG. 6, the upper broken surfaces 2221 are correspondingly provided at upper ends of some of the protruding blocks 225 respectively, and one of the through holes 211 is provided between two adjacent protruding blocks 225 being provided with the upper broken surfaces 2221. In other embodiments, multiple through holes 211 may also be provided between the two adjacent protruding blocks 225 being provided with the upper broken surfaces 2221.

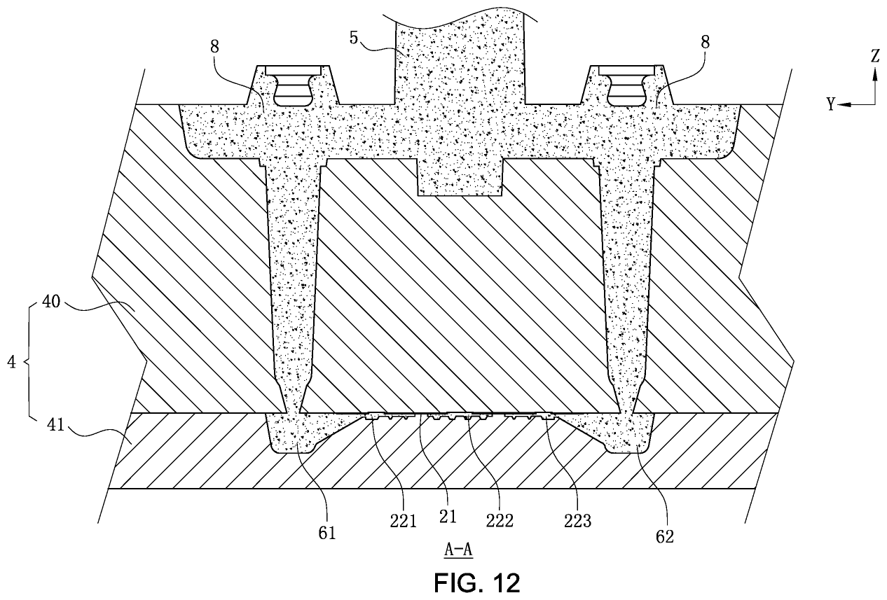

As shown in FIG. 12 to FIG. 18, the upper formed member 2A is formed in a mold 4. The mold 4 includes an upper mold 40 and a lower mold 41 pressed with each other. The lower mold 41 includes a mold cavity 42. The mold cavity 42 includes a left mold cavity 43, a middle mold cavity 44 and a right mold cavity 45 separated from one another. The lower mold 41 further includes multiple side runner channels 46. The side runner channels 46 include multiple left side runner channels 461 and multiple right side runner channels 462. The left side runner channels 461 and the right side runner channels 462 are all provided to extend in the left-right direction. A left side of the left mold cavity 43 is in communication with the left side runner channels 461, and a right side of the right mold cavity 45 is in communication with the right side runner channels 462. In other embodiments, there may be only one left side runner channel 461 and only one right side runner channel 462. The upper mold 40 includes multiple first upper runner channels 47 and multiple second upper runner channels 48, and the second upper runner channels 48 and the first upper runner channels 47 are all provided to extend vertically. In other embodiments, there may be only one first upper runner channel 47 and only one second upper runner channel 48.

As shown in FIG. 12 to FIG. 18, when the upper metal sheet 21 is provided in the mold 4, and the upper mold 40 and the lower mold 41 are pressed with each other, an upper end of the middle mold cavity 44 is in communication with the first upper runner channels 47, each first upper runner channel 47 is in communication with one of the through holes 21, and a through hole 21 is formed between two adjacent first upper runner channels 47. Each second upper runner channel 48 is in communication with one side runner channel 46. That is, each second upper runner channel 48 is in communication with one left side runner channel 461 or one right side runner channel 462. In other embodiments, multiple through holes 211 may be provided between two adjacent first upper runner channels 47.

FIG. 12 to FIG. 18 show a method for manufacturing the upper formed member 2A, which includes the following steps.

S1: the upper metal sheet 21 is provided. Multiple through holes 211 and multiple through slots 212 are formed in the upper metal sheet 21 by stamping, and multiple protruding portions 213 are formed at each of the left and right sides of the upper metal sheet 21 by stamping (referring to FIG. 5).

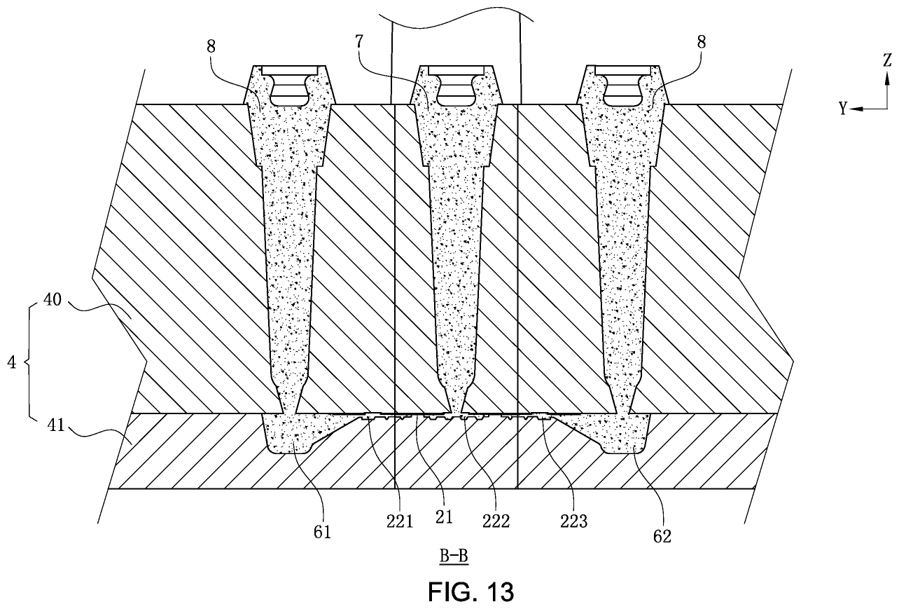

S2: as shown in FIG. 12 and FIG. 13, the mold 4 is provided. The upper metal sheet 21 is placed in the mold 4, and the upper mold 40 and the lower mold 41 are pressed with each other. A liquid insulating material 5 is injected into the mold 4, and the liquid insulating material 5 flows into the corresponding middle mold cavity 44 from the first upper runner channels 47 through the corresponding through holes 211 and then flows into the other through holes 211 not in communication with the first upper runner channels 47 through the middle mold cavity 44. Meanwhile, the liquid insulating material 5 flows into the corresponding left side runner channels 461 and the corresponding right side runner channels 462 from the second upper runner channels 48. The liquid insulating material 5 flows into the left mold cavity from the left side runner channels 461 along the lower surfaces of the corresponding protruding portions 213, and then flows into the corresponding through slots 212 through the left mold cavity 43. The liquid insulating material 5 flows into the right mold cavity 45 from the right side runner channels 462 along the lower surfaces of the corresponding protruding portions 213, and then flows into the corresponding through slots 212 through the right mold cavity 45. Then, after the liquid insulating material 5 is solidified, the left body 221 is formed in the left mold cavity 43, the middle body 222 is formed in the middle mold cavity 44, the right body 223 is formed in the right mold cavity 45, and a side connecting portion 6 is formed in each side runner channel 46. In the present embodiment, a left side connecting portion 61 is formed in each left side runner channel 461, and a right side connecting portion 62 is formed in each right side runner channel 462. Further, a first upper connecting portion 7 is formed in each first upper runner channel 47, and a second upper connecting portion 8 is formed in each second upper runner channel 48 to connect the corresponding left side connecting portion 61 or the corresponding right side connecting portion 62.

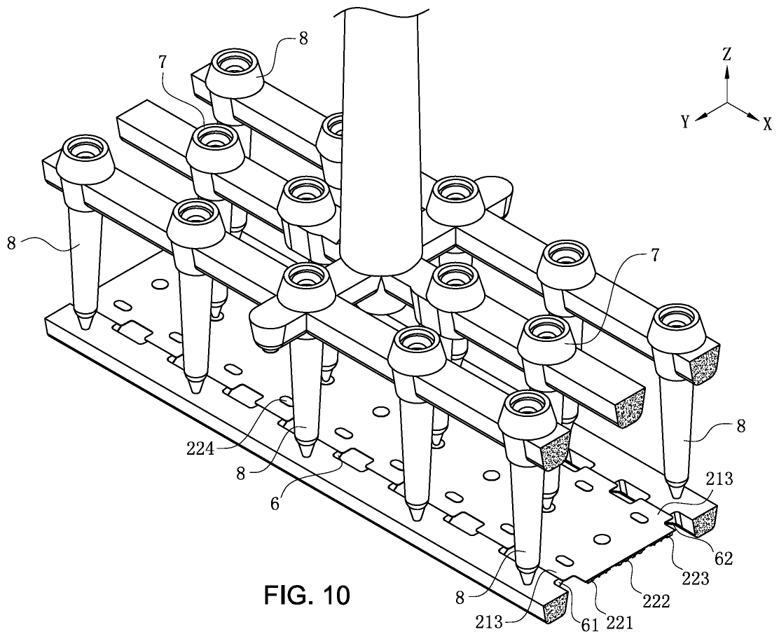

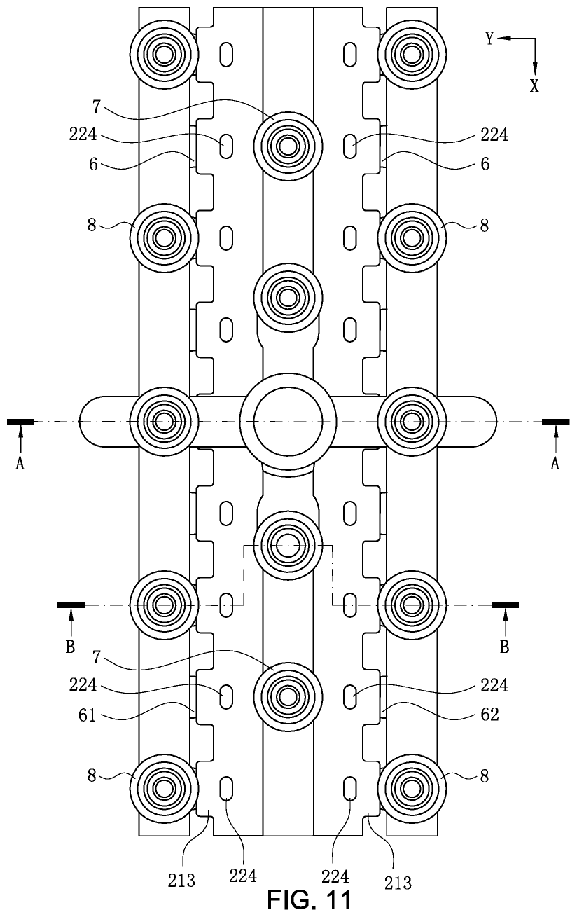

In the present embodiment, multiple second upper connecting portions 8 are arranged in two rows in the Y-axis direction, and multiple first upper connecting portions 7 are arranged in a row in the X-axis direction. The first upper connecting portions 7 in the row are located between the second upper connecting portions 8 in the two rows in the Y-axis direction, and each first upper connecting portion 7 and each second upper connecting portion 8 in the two rows adjacent thereto are staggered in the X-axis direction (referring to FIG. 10 and FIG. 11).

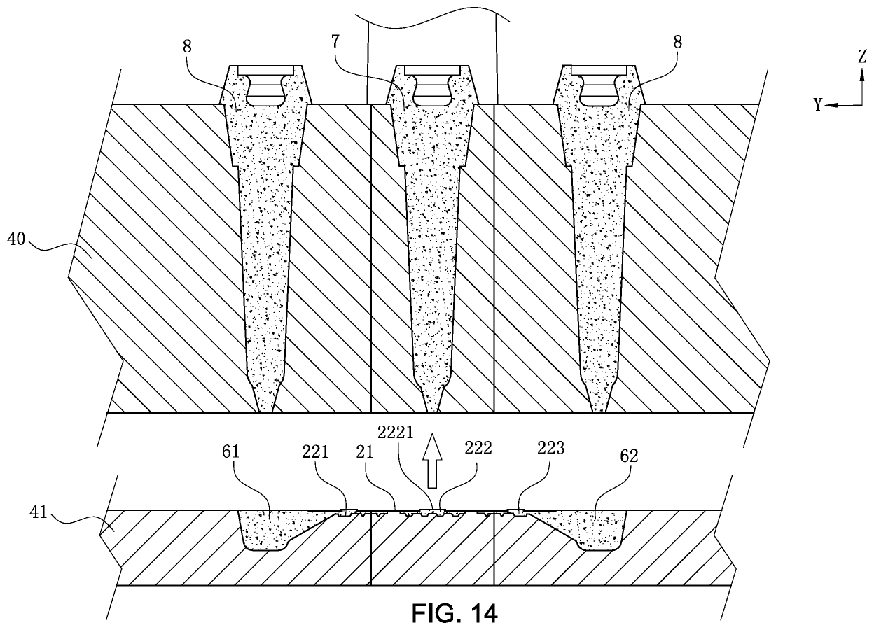

S3: as shown in FIG. 14 to FIG. 18, a joint of each left side connecting portion 61 and the left body 221, a joint of each first upper connecting portion 7 and the middle body 222, and a joint of each right side connecting portion 62 and the right body 223 are respectively disconnected, thus obtaining the upper formed member 2A.

In the present embodiment, the step S3 is further divided into steps S3-1, S3-2 and S3-3 which are sequentially performed.

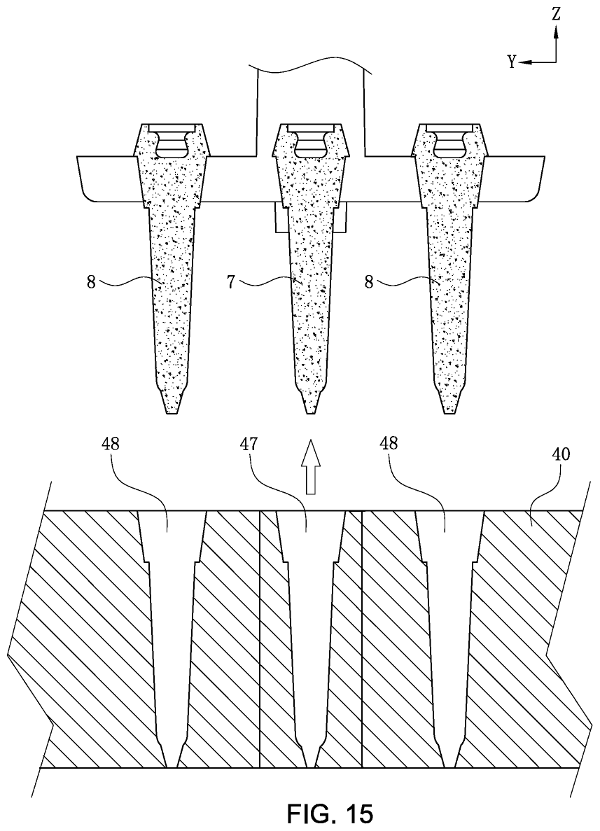

As shown in FIG. 14 and FIG. 15, in the step S3-1, the upper mold 40 is moved upward to drive the first upper connecting portions 7 and the second upper connecting portions 8 to move upward. The first upper connecting portions 7 are disconnected from the middle body 222, forming the upper broken surfaces 2221 at the upper end of the middle body 222. The second upper connecting portions 8 are disconnected from the corresponding left side connecting portions 61 or the corresponding right side connecting portions 62, and the first upper connecting portions 7 and the second upper connecting portions 8 are moved upward to be completely separated from the upper mold 40.

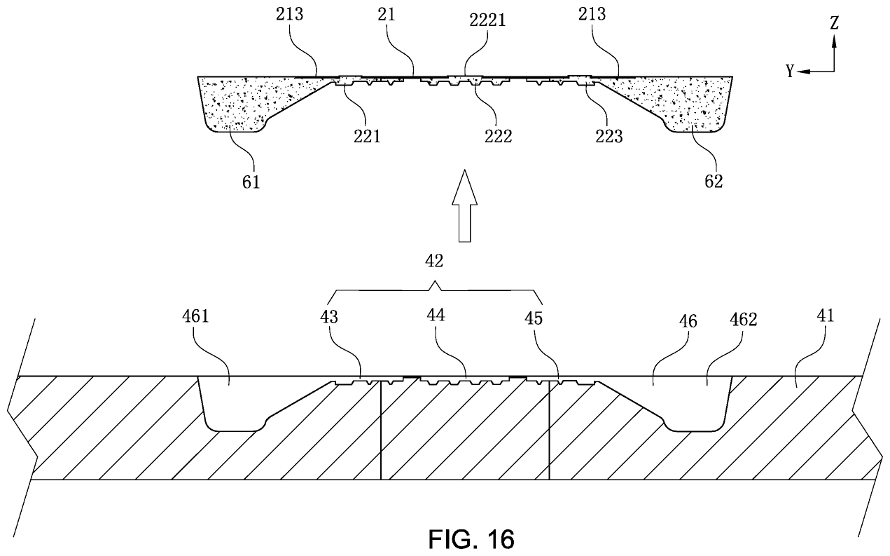

As shown in FIG. 10 and FIG. 16, in the step S3-2, the upper metal sheet 21, the side connecting portions 6 and the upper body 22 are moved upward to be completely separated from the lower mold 41.

As shown in FIG. 17 and FIG. 18, in the step S3-3, the left side connecting portions 62 are pulled downward to be disconnected from the left body 221, and the left side connecting portions 61 are removed, thereby forming the left side broken surfaces 2211 on the left body 221; and the right side connecting portions 62 are pulled downward to be disconnected from the right body 223, and the right side connecting portions 62 are removed, thereby forming the right side broken surfaces 2231 on the right body, thus obtaining the upper formed member 2A formed by the upper metal sheet 21, the left body 221, the middle body 222 and the right body 223.

As shown in FIG. 2 and FIG. 3, after the step S3, it is also necessary to bend the protruding portions 213 downward in the Z-axis direction to obtain a final product of the upper formed member 2A.

As shown in FIG. 2 to FIG. 4, the lower formed member 2B includes a lower metal sheet 23 and a lower body 24 injection molded together with the lower metal sheet 23. The lower metal sheet 23 and the upper metal sheet 21 have the same structures. That is, the lower metal sheet 23 also includes multiple through holes, multiple through slots and multiple protruding portions. The lower body 24 has a structure similar to that of the upper body 22. That is, the lower body 24 also includes a left body, a middle body and a right body separated from one another. The left body and the right body of the lower body 24 are provided symmetrically relative to the middle body of the lower body 24. The left body, the middle body and the right body of the lower body 24 are aligned with the left body 221, the middle body 222 and the right body 223 of the upper body 22 respectively. Each of the left body and the right body of the lower body 24 is provided with multiple clamping blocks fixed with the through slots of the lower metal sheet 23, and the middle body of the lower body 24 is provided with multiple protruding blocks fixed with the through holes of the lower metal sheet 23. Specific descriptions of the lower metal sheet 23 and the lower body 24 may refer to corresponding descriptions of the upper metal sheet 21 and the upper body 22, and are not hereinafter elaborated. The method for manufacturing the lower formed member 2B is the same as the method for manufacturing the upper formed member 2A. Specific descriptions of the method may refer to corresponding descriptions of the method for manufacturing the upper formed member 2A, and are not hereinafter elaborated.

To sum up, the formed member having a metal sheet and the method for manufacturing the same according to certain embodiments of the present invention has the following beneficial effects:

(1) In the present invention, the liquid insulating material 5 flows into the mold cavity 42 from the first upper runner channels 47 and the side runner channels 46. That is, a manner of feeding the liquid insulating material 5 from the side runner channels 46 is additionally adopted. With the premise that the quantity of the first upper runner channels 47 is unchanged, the side runner channels 46 are additionally provided by fully utilizing the space of the mold cavity 42, thereby increasing a flow rate of the liquid insulating material 5 flowing into the mold cavity 42, and further implementing uniform plastic feeding and completely filling the formed member 2 by to injection molding.

(2) The lower surfaces of the protruding portions 213 cover the corresponding side runner channels 46, such that no closing structures are required to be additionally provided above the corresponding side runner channels 46, thereby simplifying the structure of the mold 4, and ensuring the liquid insulating material 5 to flow into the left mold cavity 43 and the right mold cavity 45 from the side runners 46 along the lower surfaces of the corresponding protruding portions 213.

(3) A first upper connecting portion 7 is formed in each first upper runner channel 47, and a second upper connecting portion 8 is formed in each second upper runner channel 48. The first upper connecting portions 7 are arranged in a row in the X-axis direction, and are located between the second upper connecting portions 8 in the two rows in the Y-axis direction. Each first upper connecting portion 7 and each second upper connecting portion 8 in the two rows adjacent thereto are staggered in the Y-axis direction, such that the first upper connecting portions 7 and the second upper connecting portions 8 do not interfere with one another, ensuring the quantities of the first upper runner channels 47 and the second upper runner channels 48 to be sufficiently provided based on the practical need.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for manufacturing a formed member having a metal sheet, comprising:
step S1: providing the metal sheet;
step S2: providing a mold, comprising a mold cavity, at least one first upper runner channel and a plurality of side runner channels, wherein an upper end of the mold cavity is in communication with the at least one first upper runner channel, each of a left side and a right side of the mold cavity is in communication with at least one of the side runner channels respectively, the metal sheet is placed in the mold, a liquid insulating material is injected into the mold, the liquid insulating material flows into the mold cavity from the at least one first upper runner channel and the side runner channels respectively, and after the liquid insulating material is solidified, a body is formed in the mold cavity and fixed to the metal sheet, a first upper connecting portion is formed in each of the at least one first upper runner channel, and a side connecting portion is formed in each of the side runner channels; and
step S3: obtaining the formed member by disconnecting a joint of each of the first upper connecting portion and the body and a joint of each of the side connecting portion and the body.

2. The method according to claim 1, wherein:
in the step S1, at least one protruding portion is formed by stamping at each of a left side and a right side of the metal sheet; and
in the step S2, each of the at least one side runner channel is in communication to a lower surface of a corresponding one of the at least one protruding portion, and the liquid insulating material flows into the mold cavity from the side runner channel along the lower surface of the corresponding one of the at least one protruding portion.

3. The method according to claim 2, wherein in the step S3, the side connecting portion is pulled downward to be disconnected from the body and form a side broken surface on the body.

4. The method according to claim 1, wherein:
in the step S1, the metal sheet is stamped to form a plurality of through holes, and the through holes are arranged on a straight line in a front-rear direction; and
in the step S2, the upper end of the mold cavity is in communication with a plurality of first upper runner channels, each of the first upper runner channels is in communication with one of the through holes, and at least one of the through holes is provided between two adjacent ones of the first upper runner channels.

5. The method according to claim 4, wherein:
in the step S1, the metal sheet is stamped to form a plurality of through slots, each of the through holes is located between two corresponding ones of the through slots in a left-right direction, and each of the through holes and the two corresponding ones of the through slots are arranged on a straight line in the left-right direction; and
in the step S2, the liquid insulating material flows into the through slots through the mold cavity, and after the liquid insulating material is solidified, the body is fixed to the through slots.

6. The method according to claim 1, wherein the mold comprises an upper mold and a lower mold pressed with each other, and the step S3 is divided into steps S3-1, S3-2 and S3-3 sequentially performed, comprising:
step S3-1: moving the upper mold upward to drive the first upper connecting portion to move upward, and disconnecting the first upper connecting portion from the body and forming an upper broken surface on the body;
step S3-2: moving the metal sheet, the side connecting portion and the body upward to be completely separated from the lower mold; and
step S3-3: obtaining the formed member formed by the metal sheet and the body by pulling the side connecting portion downward to be disconnected from the body and removing the side connecting portion.

7. The method according to claim 1, wherein:
the mold comprises a plurality of first upper runner channels and a plurality of second upper runner channels, the first upper runner channels and the second upper runner channels are all provided to extend vertically, and each of the second upper runner channels is in communication with one of the side runner channels; and
in the step S2, the liquid insulating material flows into the corresponding side runner channels from the second upper runner channels, and a second upper connecting portion is formed in each of the second upper runner channels to be connected to the corresponding side connecting portion.

8. The method according to claim 7, wherein:
the mold comprises an upper mold and a lower mold pressed with each other; and
in the step S3, the upper mold is moved upward to drive the first upper connecting portion and the second upper connecting portions to move upward, the first upper connecting portion is disconnected from the body, and each of the second upper connecting portions is disconnected from the corresponding side connecting portion.

9. The method according to claim 7, wherein the second upper connecting portions are arranged in two rows in a left-right direction, the first upper connecting portions are arranged in a row in a front-rear direction, the first upper connecting portions in the row are located between the second upper connecting portions in the two rows in the left-right direction, and each of the first upper connecting portions and each of the second upper connecting portions in the two rows adjacent thereto are provided staggeredly in the front-rear direction.

10. A method for manufacturing a formed member having a metal sheet, comprising:
step S1: providing the metal sheet;
step S2: providing a mold, comprising a left mold cavity, a middle mold cavity and a right mold cavity separated from one another, wherein a left side of the left mold cavity is in communication with at least one left side runner channel, an upper end of the middle mold cavity is in communication with at least one first upper runner channel, a right side of the right mold cavity is in communication with at least one right side runner channel, the metal sheet is placed in the mold, a liquid insulating material is injected into the mold, the liquid insulating material flows into the left mold cavity, the middle mold cavity and the right mold cavity correspondingly from the left side runner channel, the first upper runner channel and the right side runner channel respectively, after the liquid insulating material is solidified, a left body is formed in the left mold cavity, a middle body is formed in the middle mold cavity, a right body is formed in the right mold cavity, the left body, the middle body and the right body are separated from one another and fixed to the metal sheet respectively, a left side connecting portion is formed in each of the at least one left side runner channel, a first upper connecting portion is formed in each of the at least one first upper runner channel, and a right side connecting portion is formed in each of the at least one right side runner channel; and
step S3: obtaining the formed member by disconnecting a joint of each of the left side connecting portion and the left body, a joint of each of the first upper connecting portion and the middle body, and a joint of each of the right side connecting portion and the right body.

11. The method according to claim 10, wherein:
in the step S1, at least one protruding portion is formed by stamping at each of a left side and a right side of the metal sheet; and
in the step S2, each of the at least one left side runner channel is in communication to a lower surface of a corresponding one of the at least one protruding portion located at the left side of the metal sheet, the liquid insulating material flows into the left mold cavity from the left side runner channel along the lower surface of the corresponding one of the at least one protruding portion located at the left side of the metal sheet, each of the at least one right side runner channel is in communication to a lower surface of a corresponding one of the at least one protruding portion located at the right side of the metal sheet, and the liquid insulating material flows into the right mold cavity from the right side runner channel along the lower surface of the corresponding one of the at least one protruding portion located at the right side of the metal sheet.

12. The method according to claim 11, wherein in the step S3, the left side connecting portion is pulled downward to be disconnected from the left body and form a left side broken surface on the left body, and the right side connecting portion is pulled downward to be disconnected from the right body and form a right side broken surface on the right body.

13. The method according to claim 10, wherein:
in the step S1, the metal sheet is stamped to form a plurality of through holes, and the through holes are arranged on a straight line in a front-rear direction; and
in the step S2, the upper end of the middle mold cavity is in communication with a plurality of first upper runner channels, each of the first upper runner channels is in communication with one of the through holes, and at least one of the through holes is provided between two adjacent ones of the first upper runner channels.

14. The method according to claim 10, wherein:
the mold comprises a plurality of first upper runner channels and a plurality of second upper runner channels, the first upper runner channels and the second upper runner channels are all provided to extend vertically, and each of the second upper runner channels is in communication with one of the at least one left side runner channel or one of the at least one right side runner channel; and
in the step S2, the liquid insulating material flows into the corresponding left side runner channel and the corresponding right side runner channel from the second upper runner channels, and a second upper connecting portion is formed in each of the second upper runner channels to be connected to the corresponding left side connecting portion or the corresponding right side connecting portion.

15. The method according to claim 14, wherein:
the mold comprises an upper mold and a lower mold pressed with each other; and
in the step S3, the upper mold is moved upward to drive the first upper connecting portions and the second upper connecting portions to move upward, the first upper connecting portions are disconnected from the body, and the second upper connecting portions are disconnected from the corresponding left side connecting portion and the corresponding right side connecting portion.

16. The method according to claim 14, wherein the second upper connecting portions are arranged in two rows in a left-right direction, the first upper connecting portions are arranged in a row in a front-rear direction, the first upper connecting portions in the row are located between the second upper connecting portions in the two rows in the left-right direction, and each of the first upper connecting portions and each of the second upper connecting portions in the two rows adjacent thereto are provided staggeredly in the front-rear direction.

17. The method according to claim 10, wherein the left body and the middle body are structurally different, and the left body and the right body are provided symmetrically relative to the middle body.

18. A formed member, comprising:
a metal sheet; and
a body, injection-molded together with the metal sheet, wherein a left side of the body has at least one left side broken surface, an upper end of the body has at least one upper broken surface, and a right side of the body has at least one right side broken surface.

19. The formed member according to claim 18, wherein the body comprises a left body, a middle body and a right body separated from one another, a left side of the left body has the at least one left side broken surface, an upper end of the middle body has the at least one upper broken surface, and a right side of the right body has the at least one right side broken surface.

20. The formed member according to claim 19, wherein the left body and the middle body are structurally different, and the left body and the right body are provided symmetrically relative to the middle body.

21. The formed member according to claim 18, wherein at least one protruding portion is protrudingly provided at each of a left side and a right side of the metal sheet, each of the at least one left side broken surface is provided corresponding to one of the protruding portion located at the left side of the metal sheet in a left-right direction, and each of the at least one right side broken surface is provided corresponding to one of the protruding portion located at the right side of the metal sheet in the left-right direction.

22. The formed member according to claim 21, wherein the sheet metal is provided with a plurality of through slots, each of the through slots is provided corresponding to one of the protruding portion in the left-right direction, the body is located below the metal sheet, the body is provided with a plurality of clamping blocks protruding toward the through slots correspondingly, and each of the clamping blocks is fixed to a corresponding one of the through slots and protrudes upward out of the corresponding one of the through slots.

23. The formed member according to claim 18, wherein the sheet metal is provided with a plurality of through holes, the through holes are arranged on a straight line in a front-rear direction, the body is located below the metal sheet, the body is provided with a plurality of protruding blocks protruding toward the through holes correspondingly, each of the protruding blocks is fixed to a corresponding one of the through holes and protrudes upward out of the corresponding one of the through holes, at least two of the protruding blocks are respectively provided with upper broken surfaces at upper ends thereof, and at least one of the through holes is provided between two adjacent ones of the protruding blocks provided with the upper broken surfaces.
